(19) United States
(12) Patent Application Publication
(10) Pub. No.: US 2016/0214133 A1
(43) Pub. Date: Jul. 28, 2016

(54) DEPOSITION SOURCE INCLUDING PLURALITY OF MODULES

(71) Applicant: SAMSUNG DISPLAY CO., LTD., Yongin-si (KR)

(72) Inventor: Hak-Min KIM, Hwaseong-si (KR)

(21) Appl. No.: 14/848,937

(22) Filed: Sep. 9, 2015

(30) Foreign Application Priority Data
Jan. 22, 2015 (KR) 10-2015-0010853

(51) Int. Cl. B05B 15/04; B05B 9/00

(52) U.S. Cl. CPC B05B 15/0437; B05B 9/002

(57) ABSTRACT

A deposition source includes first and second modules to store a deposition material, and to heat and evaporate the deposition material, a plurality of nozzles in each of the first and second modules to spray an evaporated deposition material, and first and second angle restriction plates along the first and second modules to limit a movement direction of the evaporated deposition material sprayed from the nozzles, wherein the first and second angle restriction plates are parallel to each other, and heights of first upper portions of the first and second angle restriction plates are lower than heights of second upper portions of the first and second angle restriction plates, the first upper portions being between the first and second modules, and the second upper portions being along the first and second modules.

### CROSS-REFERENCE TO RELATED APPLICATION

Korean Patent Application No. 10-2015-0010853, filed on Jan. 22, 2015, in the Korean Intellectual Property Office, and entitled: “Deposition Source Including Plurality of Modules,” is incorporated by reference herein in its entirety.

### BACKGROUND

1. Field

The described technology relates generally to a deposition apparatus, and more particularly, to a deposition source including a plurality of modules for use in a deposition apparatus that deposits an organic layer on an organic light emitting diode (OLED).

2. Description of the Related Art

Recently, an organic light emitting diode (OLED) display, of which luminance characteristics and viewing angle characteristics are excellent and which does not require a separate light source unit, unlike a liquid crystal display, has been highlighted as a next generation flat panel display. Since the OLED display does not require a separate light source, the OLED display may be fabricated to be small in thickness and light in weight. Also, the OLED display may exhibit improved characteristics, e.g., low power consumption, high luminance, and high reaction speed.

Generally, the OLED display includes an organic light emitting element having an anode, an organic emission layer, and a cathode. The organic light emitting element emits light when holes and electrons are injected from the anode and the cathode to form excitons in the organic emission layer, and the excitons transition to a ground state. The anode and the cathode may be formed as metal thin films or transparent conductive thin films, and the organic emission layer may be formed as at least one organic thin film.

A deposition apparatus is used to form the at least one organic thin film, the metal thin films, and the like on a substrate of an OLED display. The deposition apparatus includes a crucible filled with a deposition material and a nozzle used to spray the deposition material. When the crucible is heated at a predetermined temperature, the deposition material within the crucible is evaporated and the evaporated deposition material is sprayed through the nozzle. The deposition material sprayed from the nozzle is deposited on the substrate to form a thin film.

Thermal evaporation is used when the emission layer of an OLED display is deposited. In this case, a material evaporated from a deposition source moves toward the substrate and passes through a deposition mask, thereby achieving selective deposition. Due to the selective deposition, it is possible to form pixels implementing different colors, such as red, green, blue, and the like. Generally, a deposition source mainly includes a cooling housing, a heater frame, a crucible, a nozzle, and an angle limiting plate.

### SUMMARY

An exemplary embodiment provides a deposition source including first and second modules to store a deposition material, and to heat and evaporate the deposition material, a plurality of nozzles in each of the first and second modules to spray an evaporated deposition material, and first and second angle restriction plates along the first and second modules to limit a movement direction of the evaporated deposition material sprayed from the nozzles, wherein the first and second angle restriction plates are parallel to each other, and heights of first upper portions of the first and second angle restriction plates are lower than heights of second upper portions of the first and second angle restriction plates, the first upper portions being between the first and second modules, and the second upper portions being along the first and second modules.

The first upper portions of the first and second angle restriction plates may be V-shaped.

The first upper portions of the first and second angle restriction plates may have a uniform height which is lower than heights of peripheral regions.

The first upper portions of the first and second angle restriction plates may be spaces separating each of the first and second angle restriction plates into two plates spaced apart from each other.

Each of the first and second angle restriction plates may be continuous along each of the first and second modules, and along a space between the first and second modules.

Another exemplary embodiment provides a deposition source, including first and second modules to store a deposition material, and to heat and evaporate the deposition material, a plurality of nozzles in each of the first and second modules to spray an evaporated deposition material, first and second angle restriction plates along the first module to limit a movement direction of the evaporated deposition material sprayed from the nozzles disposed in the first module, and third and fourth angle restriction plates along the second module to limit a movement direction of the evaporated deposition material sprayed from the nozzles disposed in the second module, wherein the first and second angle restriction plates are parallel to each other, and the third and fourth angle restriction plates are parallel to each other.

A distance between the first angle restriction plate and the third angle restriction plate may be equal to a distance between the second angle restriction plate and the fourth angle restriction plate.

A distance between the first angle restriction plate and the third angle restriction plate may be smaller than a distance between the first angle restriction plate and the second angle restriction plate.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic diagram of a deposition amount of an organic material deposited on a substrate with respect to a height of an angle limiting plate according to embodiments.

FIG. 2 illustrates a schematic diagram of a deposition source according to a first exemplary embodiment and a deposition thickness formed by the deposition source.

FIG. 3 illustrates a schematic diagram of a deposition source according to a second exemplary embodiment.

FIG. 4 illustrates a schematic diagram of a deposition source according to a third exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Portions unrelated to the description may be omitted for clarity, and embodiments are not necessarily limited to the illustration. Further, the term “on” means that a component is disposed over or under a target portion, and does not necessarily mean that a component is essentially disposed on an upper portion with reference to gravity. In addition, unless explicitly described to the contrary, the word “comprise” and variations such as “comprises” or “comprising”, will be understood to imply the inclusion of stated elements but not the exclusion of any other elements.

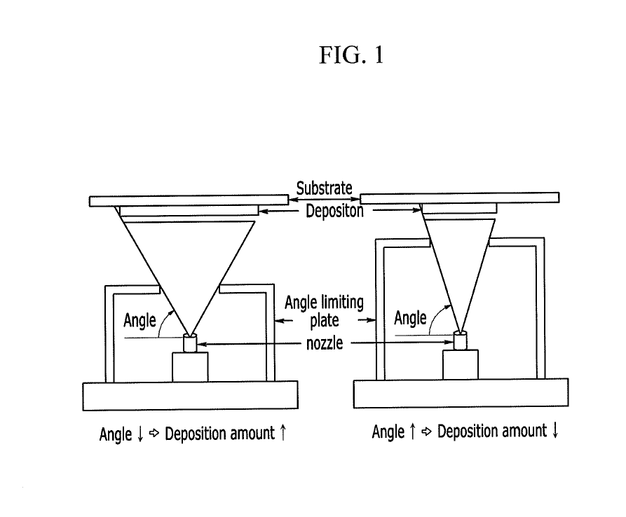

FIG. 1 is a schematic diagram of a deposition amount of an organic material deposited on a substrate with respect to a height of an angle limiting plate, according to example embodiments.

In general, an angle limiting plate of a deposition source is formed to be disposed over two modules. The deposition thickness increases when a nozzle and a substrate are disposed in a vertical direction. However, since it is difficult to dispose the nozzle between modules in a two-module deposition source, the deposition thickness in a central portion of the substrate may be thinner than in peripheral portions.

Therefore, referring to FIG. 1, an angle limiting plate, i.e., an angle restriction plate, for a deposition source, according to embodiments, is used to form a uniform film on a substrate by controlling the amount of an organic material sprayed from a nozzle. That is, when a height of the angle limiting plate increases, the amount of organic material particles directed from the nozzle toward the substrate decreases. Therefore, the deposition thickness is also reduced. Similarly, when the height of the angle limiting plate decreases, the amount of organic material particles directed toward the substrate increases, and therefore, the deposition thickness increases.

Therefore, according to embodiments, it is possible to increase the amount of organic material particles sprayed toward the substrate by changing the height of the angle limiting plate corresponding to a substrate region between modules, which is a region in which the deposition thickness is thin, thereby achieving a uniform deposition thickness. Specific exemplary embodiments will be described in detail below.

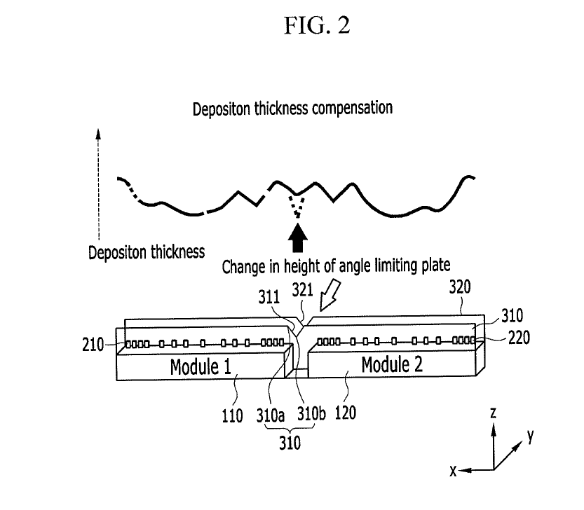

FIG. 2 is a diagram showing a configuration of a deposition source according to a first exemplary embodiment and a deposition thickness formed by the deposition source.

Referring to FIG. 2, the deposition source according to the first exemplary embodiment may include first and second modules 110 and 120 configured to store a deposition material, and to heat and evaporate the deposition material. The deposition source may further include a plurality of nozzles 210 and 220 respectively formed in the first and second modules 110 and 120 to spray the evaporated deposition material, and first and second angle restriction plates 310 and 320 provided in the first and second modules 110 and 120 to limit a movement direction of the deposition material sprayed from the nozzles 210 and 220.

As illustrated in FIG. 2, the first and second angle restriction plates 310 and 320 are disposed parallel to each other, e.g., the first and second angle restriction plates 310 and 320 may be spaced apart from each other along the y-axis. For example, as illustrated in FIG. 2, each of the first and second angle restriction plates 310 and 320 may, e.g., continuously, extend in the xz-plane along both the first and second modules 110 and 120. For example, as illustrated in FIG. 2, the first and second modules 110 and 120 may be positioned in the space between the first and second angle restriction plates 310 and 320 to be adjacent to each other along the x-axis.

As further illustrated in FIG. 2, the height of the first and second angle restriction plates 310 and 320 is higher than the first and second modules 110 and 120 along the z-axis. Further, heights of upper portions of the first and second angle restriction plates 310 and 320, which are formed between the first and second modules 110 and 120, are lower than those of other portions. For example, as illustrated in FIG. 2, the first angle restriction plate 310 includes a first height 310a extending along an entirety of each of the first and second modules 110 and 120 in the x-axis direction, and a second height 310b in a region between the first and second modules 110 and 120, with the first height 310a being higher than the second height 310b relative to bottoms of the first angle restriction plate 310 and the first and second modules 110 and 120. The second angle restriction plate 320 has a same structure to that of the first angle restriction plate 310, and therefore, detailed description thereof will no be repeated. In this case, the upper portions of the first and second angle restriction plates 310 and 320 formed between the first and second modules 110 and 120, i.e., a portion including the lower height, may be formed by cutting the upper portion in a V-shape, i.e., V-shaped cut portions 311 and 321 in FIG. 2.

In a structure as described above, a large number of organic material particles pass through the V-shaped cut portions 311 and 312 of the upper portions of the first and second angle restriction plates 310 and 320. Therefore, the organic material particles sprayed through the V-shaped cut portions 311 and 321 are easily deposited on a portion of the substrate between the first module 110 and the second module 120, thereby forming a uniform film.

That is, in a structure according to a first exemplary embodiment, a large number of deposition material particles pass through the V-shaped cut portions 311 and 321 of the upper portions of the first and second angle restriction plates 310 and 320, even when the number of the deposition material particles transferred from the nozzles 210 and 220 is relatively small. In addition, a small number of deposition material particles pass through other portions than the V-shaped cut portions 311 and 321 of the upper portions of the first and second angle restriction plates 310 and 320, even when the number of the deposition material particles transferred from the nozzles 210 and 220 is relatively large. Thereby, it is possible to achieve uniform deposition on the overall substrate.

Referring to the graph in FIG. 2, it can be seen that a film formed on the substrate has a relatively uniform thickness. In particular, a portion of the film between the first module 110 and the second module 120 (indicated by a black arrow) has a relatively uniform. In contrast, if heights of the first and second angle restriction plates 310 and 320 were constant along the first and second modules 110 and 120, as well as along a space between the first and second modules 110 and 120, i.e., if the first and second angle restriction plates 310 and 320 had no cut portions 311 and 321, a portion of a film between the first module 110 and the second module 120 would have a substantially reduced thickness, i.e., the graph would have sharply dropped in the regions between the first module 110 and the second module 120.

In the case of adjusting heights of portions of the first and second angle restriction plates 310 and 320 which are disposed between the first module 110 and the second module 120, it is necessary to take into account a distance between the first and second modules 110 and 120 and the nozzles 210 and 220. Further, when necessary, an optimal height may be determined through several test values.

Various modifications of the first exemplary embodiment are possible. In particular, the upper portions or parts of the upper portions of the first and second angle restriction plates 310 and 320, which are formed between the first module 110 and the second module 120, may be formed to have heights lower than those of the peripheral regions.

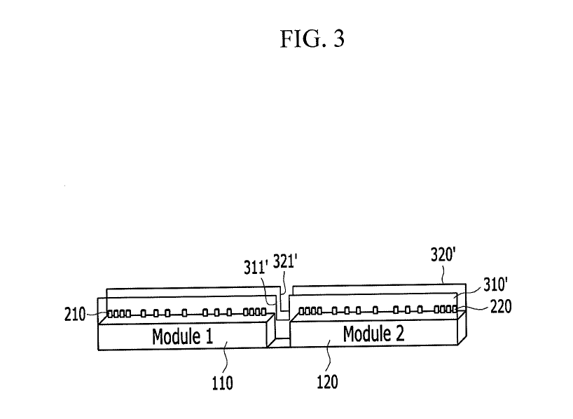

FIG. 3 is a diagram showing a configuration of a deposition source according to a second exemplary embodiment.

Referring to FIG. 3, a deposition source according to a second exemplary embodiment includes the first and second modules 110 and 120 configured to store a deposition material, and to heat and evaporate the deposition material, the plurality of nozzles 210 and 220 respectively formed in the first and second modules 110 and 120 to spray the evaporated deposition material, and first and second angle restriction plates 310′ and 320′ provided in the first and second modules 110 and 120 to limit a movement direction of the deposition material sprayed from the nozzles 210 and 220. The first and second angle restriction plates 310′ and 320′ are substantially the same as the first and second angle restriction plates 310 and 320 in FIG. 2, with the exception of the shape and depth of the cut portions between the first and second modules 110 and 120

In detail, as illustrated in FIG. 3, the first and second angle restriction plates 310′ and 320′ are disposed parallel to each other, and heights of upper portions of the first and second angle restriction plates 310 and 320 formed between the first and second modules 110 and 120 are lower than those of other portions. In this case, the upper portions of the first and second angle restriction plates 310′ and 320′ formed between the first and second modules 110 and 120 may be formed to be cut at a uniform height which is lower than heights of peripheral regions. That is, the upper portions of the first and second angle restriction plates 310 and 320 formed between the first module 110 and the second module 120 are formed to be cut in a rectangular shape.

As in the first exemplary embodiment, according the second embodiment, a large number of deposition material particles pass through the rectangular cut portions 311′ and 321′ of the upper portions of the first and second angle restriction plates 310′ and 320′, even when the number of the deposition material particles transferred from the nozzles 210 and 220 is relatively small. In addition, a small number of deposition material particles pass through other portions than the rectangular cut portions 311′ and 321′ of the upper portions of the first and second angle restriction plates 310′ and 320′, even when the number of the deposition material particles transferred from the nozzles 210 and 220 is relatively large. Thereby, it is possible to achieve uniform deposition on the overall substrate.

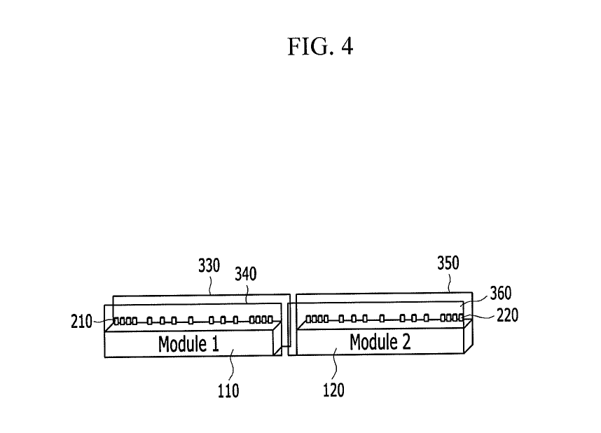

FIG. 4 is a diagram showing a configuration of a deposition source according to a third exemplary embodiment.

Referring to FIG. 4, the deposition source according to the third exemplary embodiment includes first and second modules 110 and 120 configured to store a deposition material, and to heat and evaporate the deposition material, a plurality of nozzles 210 and 220 respectively formed in the first and second modules 110 and 120 to spray the evaporated deposition material, first and second angle restriction plates 330 and 340 provided in the first modules 110 and 120 to limit a movement direction of the deposition material sprayed from the nozzles 210 disposed in the first module 110, and third and fourth angle limiting plates 350 and 360 provided in the second module 120 to limit a movement direction of the deposition material sprayed from the nozzles 220 disposed in the second module 120.

The first and second angle restriction plates 330 and 340 may be disposed parallel to each other, and the third and fourth angle limiting plates 350 and 360 may be disposed parallel to each other. The distance between the first angle restriction plate 330 and the third angle limiting plate 350 may be equal to the distance between the second angle restriction plate 340 and the fourth angle limiting plate 360, and the distance between the first angle restriction plate 330 and the third angle limiting plate 350 may be smaller than the distance between the first angle restriction plate 140 and the second angle restriction plate 120.

The third exemplary embodiment is different from the first and second exemplary embodiments in that the angle restriction plates 330, 340, 350 and 360 are formed to be, e.g., completely, separated from each other with respect to the first and second modules 110 and 120. As in the first and second exemplary embodiments, according the third embodiment, a large number of deposition material particles pass through portions in which the first and fourth angle limiting plates 330, 340, 350, and 360 are not formed, even when the number of the deposition material particles transferred from the nozzles 210 and 220 is relatively small. In addition, a small number of deposition material particles pass through pass through portions in which the first and fourth angle limiting plates 330, 340, 350, and 360 are formed even when the number of the deposition material particles transferred from the nozzles 210 and 220 is relatively large. Therefore, it is possible to achieve uniform deposition on the overall substrate.

As described above, according to embodiments, it is possible to achieve a uniform deposition thickness formed on a substrate by changing, e.g., adjusting, a height or shape of a part of an upper portion of an angle limiting plate disposed among the plurality of modules. Therefore, it is possible to employ the deposition source as a large-area organic deposition source. Although the number of modules is, e.g., two in the first to third exemplary embodiments, more than two modules may be used.

By way of summation and review, a conventional deposition source includes a nozzle and an angle limiting plate, and the deposition source is configured by one module. On the other hand, with the increased size of displays, the deposition source has employed a plurality of modules. As the nozzle has a structure engaged with the crucible, when a deposition source includes more than one module, e.g., two modules, it is hard to dispose the nozzle between the two modules due to thicknesses of the cooling housing and the heater frame. Due to this, a deposition thickness in a deposition region between modules may decrease, and therefore, it may be difficult to secure a uniform deposition thickness in the substrate.

In contrast, a deposition source, according to embodiments, includes a plurality of modules that achieve a uniform deposition thickness of a film formed on a substrate. That is, the plurality of modules of the deposition source achieve a uniform deposition thickness therebetween by changing a height or shape of a part of an upper portion of an angle limiting plate disposed among the plurality of modules. As such, it is possible to employ the deposition source as a large-area organic deposition source.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A deposition source, comprising:
first and second modules to store a deposition material, and to heat and evaporate the deposition material;
a plurality of nozzles in each of the first and second modules to spray an evaporated deposition material; and
first and second angle restriction plates along the first and second modules to limit a movement direction of the evaporated deposition material sprayed from the nozzles,
wherein the first and second angle restriction plates are parallel to each other, and heights of first upper portions of the first and second angle restriction plates are lower than heights of second upper portions of the first and second angle restriction plates, the first upper portions being between the first and second modules, and the second upper portions being along the first and second modules.

2. The deposition source as claimed in claim 1, wherein the first upper portions of the first and second angle restriction plates are V-shaped.

3. The deposition source as claimed in claim 1, wherein the first upper portions of the first and second angle restriction plates have a uniform height which is lower than heights of peripheral regions.

4. The deposition source as claimed in claim 1, wherein the first upper portions of the first and second angle restriction plates are spaces separating each of the first and second angle restriction plates into two plates spaced apart from each other.

5. The deposition source as claimed in claim 1, wherein each of the first and second angle restriction plates is continuous along each of the first and second modules, and along a space between the first and second modules.

6. A deposition source, comprising:
first and second modules to store a deposition material, and to heat and evaporate the deposition material;
a plurality of nozzles in each of the first and second modules to spray an evaporated deposition material;
first and second angle restriction plates along the first module to limit a movement direction of the evaporated deposition material sprayed from the nozzles disposed in the first module; and
third and fourth angle restriction plates along the second module to limit a movement direction of the evaporated deposition material sprayed from the nozzles disposed in the second module,
wherein the first and second angle restriction plates are parallel to each other, and the third and fourth angle restriction plates are parallel to each other.

7. The deposition source as claimed in claim 6, wherein a distance between the first angle restriction plate and the third angle restriction plate is equal to a distance between the second angle restriction plate and the fourth angle restriction plate.

8. The deposition source as claimed in claim 6, wherein a distance between the first angle restriction plate and the third angle restriction plate is smaller than a distance between the first angle restriction plate and the second angle restriction plate.
